(19) United States
(12) Patent Application Publication
(10) Pub. No.: US 2019/0036363 A1
(43) Pub. Date: Jan. 31, 2019

(54) Apparatus and Method

(71) Applicant: KSG Global Consulting Limited, Stonehaven (GB)

(72) Inventors: Keith Scott Gaskin, Stonehaven (GB); George James Gaskin, Stonehaven (GB)

(21) Appl. No.: 16/047,430

(22) Filed: Jul. 27, 2018

(30) Foreign Application Priority Data
Jul. 31, 2017 (GB) 1712312.6

(51) Int. Cl. H02J 7/00; H02J 7/02; H02J 50/10

(52) U.S. Cl. CPC H02J 7/0044; H02J 50/10; H02J 7/025

(57) ABSTRACT

A housing (70) for a battery-powered electronic device is provided, the housing (70) comprising a wireless charging coil assembly (50) adapted to selectively wirelessly charge the battery.

An adapter (1) has first and second ends, the first end comprising a tip (5) adapted to be inserted into a charging socket in the electronic device and the second end comprising a magnetic connector (10) suitable for magnetic connection to a complementary charging or data transfer cable.

At least two electrical connectors (20; 120) are further disposed on the adapter (1) and which are selectively electrically connected to the tip (5).

The coil assembly (50) comprises an inductive receiver coil (55) and at least two electrical contacts (62) in electrical connection with the inductive receiver coil (55), where the electrical connectors (20; 120) on the adapter (1) are arranged to abut the said electrical contacts (62) of the coil assembly (50) when the battery powered electronic device is located within the housing (70) when the apparatus is in use.

The electrical connectors (20; 120) on the adaptor (1) are arranged to be separable from the electrical contacts (62) of the coil assembly (50) when the battery powered electronic device is removed from the housing (70) such that the battery powered electronic device and the adapter (1) (whilst its tip (5) is still inserted in the charging socket) can be physically separated from the housing (70).

### APPARATUS AND METHOD

The present invention relates to a device for electrical transfer of power and/or data to or from personal portable electronic devices. In particular, the present invention relates to a combined magnetic charging and data transfer device for personal portable electronic devices.

### BACKGROUND OF THE INVENTION

Personal portable electronic devices such as mobile telephones, tablets, e-readers etc. generally comprise a socket incorporated into the body of the device, into which a connection may be made for electrically charging the battery of the device. The socket generally is also suitable for connection between the device and a computer, for example, to transfer data to or from the computer.

Some personal portable electronic devices can also be charged wirelessly via an inductive receiver coil. The coil may be contained within the device itself and directly connected to the device battery, and the battery is charged while there is a current flowing through the coil. Alternatively, the inductive receiver coil may be contained within a case that fits around the device. The coil is connected to a tip which fits into the charging socket of the device. However, the socket is then blocked by the tip, and the tip must be removed before data may be transferred via a cable plugged into the socket.

### SUMMARY OF THE INVENTION

According to a first aspect of the present invention there is provided a charging apparatus for a battery-powered electronic device, the apparatus comprising a housing for the battery-powered electronic device, the housing further comprising a wireless charging coil assembly adapted to selectively wirelessly charge said battery; and
an adapter having a first end and a second end, the first end comprising a tip adapted to be inserted into a charging socket in the electronic device and the second end comprising a magnetic connector suitable for magnetic connection to a complementary charging or data transfer cable;
wherein the apparatus is characterised by further including at least two electrical connectors disposed on the adapter, and wherein the electrical connectors of the adapter are selectively electrically connected to the tip;
wherein the coil assembly comprises an inductive receiver coil and at least two electrical contacts in electrical connection with the inductive receiver coil;
wherein the electrical connectors on the adapter are arranged to abut the said electrical contacts when the battery powered electronic device is located within the housing when the apparatus is in use; and
wherein the electrical connectors on the adaptor are arranged to be separable from the electrical contacts of the coil assembly when the battery powered electronic device is removed from the housing such that the battery powered electronic device and the adapter inserted in the charging socket can be physically separated from the housing.

According to a second aspect of the present invention there is provided a wireless charging coil assembly for a battery-powered electronic device, wherein the coil assembly comprises an inductive receiver and is characterised by comprising at least two electrical contacts configured to selectively connect to at least two corresponding electrical connectors disposed on an adapter configured to be received within a charging socket of the electronic device;
characterised in that the electrical contacts of the coil assembly are arranged to be separable from the electrical connectors of the adaptor when the battery powered electronic device is removed from the coil assembly such that the battery powered electronic device and the adapter inserted in the charging socket can be physically separated from the coil assembly.

According to a third aspect of the present invention there is also provided an adapter having a first end and a second end, the first end comprising a tip adapted to be inserted into a charging socket in an electronic device and the second end comprising a magnetic connector suitable for magnetic connection to a complementary charging or data transfer cable;
wherein the adapter is characterised by further comprising at least two electrical connectors disposed on the adapter, and wherein the electrical connectors are configured to connect to at least two electrical contacts in electrical connection with a wireless charging coil assembly;
characterised in that the electrical connectors on the adaptor are arranged to be separable from the electrical contacts of the coil assembly when the battery powered electronic device is removed from the wireless charging coil assembly such that the battery powered electronic device and the adapter inserted in the charging socket can be physically separated from the wireless charging coil assembly.

Preferably, the housing comprises a case.

Optionally the adapter comprises a flanged portion that abuts against the outer surface of an electronic device when the tip is inserted into the charging socket.

Optionally the flange is substantially rectangular in profile, or optionally ovalised, or a flattened oval, having longer upper and lower faces than side faces. Optionally two or more holes are provided in the flange, preferably the lower face of the flange, optionally also on the upper face of the flange, optionally also on the right side face of the flange, optionally also on the left side face of the flange, optionally extending between the outer face of the flange to inner circuitry of the adapter. Optionally the electrical connectors are inserted, mounted, or otherwise fixed into the holes, such that optionally the electrical connectors are at least partially protruding from the outer face of the flange. Optionally the electrical connectors are resiliently biased, preferably by a suitable spring mechanism, in an outwards direction such that at least one electrical connector provides a biased connection between itself and the said respective electrical contact of the coil assembly when the respective electrical connector contacts the said respective electrical contact.

Optionally, the respective spring mechanism is compressed when the respective electrical connector contacts the said respective connections in electrical contact with the wireless charging coil assembly. Preferably the spring mechanism when compressed provides a spring-loaded connection between the electrical connectors and the said respective electrical contact of the wireless charging coil assembly. Preferably, when the electrical connectors are compressed, they make contact with terminals within the adapter that terminate the connections from the inductive receiver coil. Preferably the electrical connectors are pogo connectors. Preferably the electrical connectors are affixed within the holes with adhesive that is suitable for use with electrical and/or electronic components.

Optionally one or more of the pogo connectors comprises an inner end that is adapted to be in contact with circuitry within the adapter and an outer end that is adapted to be in contact with the contact pads. Optionally both the inner and outer ends of the pogo connector are movable and preferably both the inner end and outer end are independently movable with respect to one another and optionally both are resiliently biased. Optionally the inner and outer ends are resiliently biased in opposing directions. Optionally having both ends of the pogo connectors being resiliently biased permits the pogo connector to absorb relative movement of the adapter and/or the components within the adapter and the contact pads. Optionally this enhances the connections between the internal components of the adapter and the contact pads. Optionally the or each pogo connector is arranged such that the inner and outer ends are always under resilient pressure from the internal spring mechanism. Having both ends of the connector resiliently biased also compensates for any variations in manufacturing tolerances within the adapter or other components, reducing the likelihood of contact between the connector and the components or contact pads being unintentionally disconnected.

Alternatively the electrical connectors are, by way of example, ball bearings or rollers, optionally seated on a spring or similar device.

Preferably the connections in electrical contact with the wireless charging coil assembly are contact pads. Preferably the contact pads are aligned with the electrical connectors when the adapter is firstly inserted into a charging socket of the battery powered electronic device and secondly the battery powered electronic device is placed into and secured within the housing of the case.

Optionally the coil assembly is adapted to be installed within a case for an electronic device. Optionally the case comprises a back and sides, each with an inner surface and an outer surface. Optionally the depth of the sides of the case are increased relative to cases without a coil assembly contained therein, optionally increased by approximately 2 mm. Preferably the inductive receiver coil is secured to the inner surface of the back of the case, for example with an adhesive. Optionally one side of the case comprises an aperture that is designed to axially align with the charging socket of the electronic device when the electronic device is contained within the case. Optionally the inductive receiver coil is spaced from the edge of the case. Optionally at least two wires extend from the coil towards the aperture in the case that is adapted to align with the charging socket of the electronic device. Optionally the respective contact pads electrically connect to these respective wires, optionally at positive and negative terminals, optionally within a contact block upon which the contact pads are affixed. Optionally the contact pads are fixed to the contact block, optionally with adhesive. Optionally the contact block is fixed within the aperture on the case, optionally with adhesive. Optionally the contact pads are adjacent to the charging socket of the electronic device when the electronic device is contained within the case. Optionally the contact block affixes within the aperture in the case to permit contact and more preferably electrical contact between the contact pads and the electrical connectors when the adapter is inserted into the charging socket of the electronic device and when the case is provided or fitted around the battery-powered electronic device. Optionally the case comprises a lip or similar extension of the case onto which the contact block may be affixed. Preferably, there is no further and/or permanent wiring between the adapter and the case that houses the battery powered electronic device such that the adapter is physically detached from the case when the battery powered electronic device is removed from the case even whilst the adapter is located in the charging socket of the battery powered electronic device.

Optionally the connection between the electrical connectors, e.g. pogo connectors and the contact pads adjacent to the charging socket, is adapted to selectively allow transfer of electrical energy between the electrical connectors and the contact pads. Optionally when the inductive receiver coil is exposed to an electromagnetic field, a current is set up, producing electrical energy that may be transferred to the contact pads and the electrical connectors. As the electrical connectors are in turn electrically connected to the tip of the adapter, the electrical energy from the receiver coil can thus be transferred through the charging socket to the battery of the electronic device for charging of the battery.

Optionally two or more further wires extend from the coil and optionally electrically connect with respective two or more further contact pads that are affixed to the inner surface of the case. Optionally the case comprises two apertures that are aligned with the contact pads affixed to the inner surface of the case. Optionally these contact pads may be directly connected with a charging device, for example if the charging device comprises two protruding prongs, these may be inserted into the apertures in the case and abut against the contact pads affixed to the inner surface of the case.

Optionally the charging apparatus further comprises two or more ferrous pads, optionally four ferrous pads. The ferrous pads are optionally secured to the inner surface of the electronic device case, optionally with an adhesive. Optionally the ferrous pads are spaced apart. Optionally at least one ferrous pad is magnetic, in which case it is arranged so that its positive pole is directed away from the electronic device when the electronic device is received within the case and at least one other magnetic ferrous pad is arranged so that its negative pole is directed away from the electronic device when the electronic device is received within the case. Arranging the magnetic ferrous pads in this way means that both positive and negative poles are facing towards a charging device, for example a wireless charging station and offers a means of securing the encased electronic device in position on the wireless charging station or similar device. Alternatively, the ferrous pads are not magnetised in which case a magnet can be provided in the wireless charging station such that it attracts the ferrous pads and in so doing secures the encased electronic device in position on the wireless charging station.

Optionally the case can comprise recesses shaped to receive the components of the coil assembly, for example the ferrous pads. This allows the electronic device to sit flush against the inner surface of the back of the case and reduces the risk of damage to both the electronic device and the coil assembly itself.

Optionally the magnetic connector on the adapter is adapted to connect to a magnetic cable for wired charging and/or data transfer. This offers the advantage that the adapter does not require removal and reinsertion from or into the charging socket when a wired connection is desired, thus reducing the risk of fatigue of the adapter components and protecting the charging socket of the electronic device itself from debris ingress and damage. Additionally, and advantageously, a single magnetic cable may be used with several differing electronic devices, as a range of adapters may be provided with a variety of tip forms to suit the charging socket provided for the various different types of electronic device (e.g. Lightning® connector for Apple® iOS® devices; micro USB for Samsung Galaxy® devices, etc). Optionally the cable may comprise a standard female USB connector at its opposite end to the magnetic connector, or alternatively a plug suitable for a mains socket, or another form of suitable connector.

Optionally a monitoring circuit is installed within the adapter, optionally within the flange, optionally at the internal end of one or more of the said holes in the flange of the adapter. Optionally at least one of the electrical connectors is in selective electrical connection with the monitoring circuit, preferably when the electrical connector is in a compressed configuration, i.e. when one or both ends of the connector is depressed. Optionally the monitoring circuit is adapted to detect both wireless and wired charging occurring simultaneously and, if that simultaneous charging state is detected, is further adapted to switch off the supply of electrical energy from the wireless charging coil, thus protecting the battery of the electronic device. Optionally the monitoring circuit is biased in order to give preference to the supply carrying highest amperage.

Alternatively, and more preferably, the monitoring circuit may be placed within the coil assembly, optionally as one part of a PCB that may also comprise other functions such as temperature control, or current control. Optionally the monitoring circuit comprises a detection device that detects current flowing back from the adapter when the wired connection is in place. Optionally when the monitoring circuit detects current backflow from the adapter, the wireless charging is shut off in order to protect the battery of the electronic device, in preference of allowing direct charging via the charging cable to the data port of the electronic device via the tip.

The various aspects of the present invention can be practiced alone or in combination with one or more of the other aspects, as will be appreciated by those skilled in the relevant arts. The various aspects of the invention can optionally be provided in combination with one or more of the optional features of the other aspects of the invention. Also, optional features described in relation to one aspect can optionally be combined alone or together with other features in different aspects of the invention. Any subject matter described in this specification can be combined with any other subject matter in the specification to form a novel combination.

Various aspects of the invention will now be described in detail with reference to the accompanying figures. Still other aspects, features, and advantages of the present invention are readily apparent from the entire description thereof, including the figures, which illustrates a number of exemplary aspects and implementations. Any subject matter described in the specification can be combined with any other subject matter in the specification to form a novel combination. The invention is also capable of other and different examples and aspects, and its several details can be modified in various respects, all without departing from the scope of the present invention as defined by the claims. Accordingly, the drawings and descriptions are to be regarded as illustrative in nature, and not as restrictive. Furthermore, the terminology and phraseology used herein is solely used for descriptive purposes and should not be construed as limiting in scope. Language such as “including”, “comprising”, “having”, “containing” or “involving” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes.

Any discussion of documents, acts, materials, devices, articles and the like is included in the specification solely for the purpose of providing a context for the present invention. It is not suggested or represented that any or all of these matters formed part of the prior art base or were common general knowledge in the field relevant to the present invention.

In this disclosure, whenever a composition, an element or a group of elements is preceded with the transitional phrase “comprising”, it is understood that we also contemplate the same composition, element or group of elements with transitional phrases “consisting essentially of”, “consisting”, “selected from the group of consisting of”, “including” or “is” preceding the recitation of the composition, element or group of elements and vice versa. In this disclosure, the words “typically” or “optionally” are to be understood as being intended to indicate optional or non-essential features of the invention which are present in certain examples but which can be omitted in others without departing from the scope of the invention.

All numerical values in this disclosure are understood as being modified by “about”. All singular forms of elements, or any other components described herein are understood to include plural forms thereof and vice versa. References to directional and positional descriptions such as upper and lower and directions e.g. “up”, “down” etc. are to be interpreted by a skilled reader in the context of the examples described and are not to be interpreted as limiting the invention to the literal interpretation of the term, but instead should be as understood by the skilled addressee.

### BRIEF DESCRIPTION OF THE DRAWINGS

In the accompanying drawings:

FIG. 1 shows a perspective view of an example of a coil assembly in accordance with the first and second aspects of the present invention;

FIGS. 2-7 show various views of an example of an adapter in accordance with the first and third aspects of the present invention;

FIG. 8 shows a perspective view of the underside of the adapter of FIGS. 2-7;

FIG. 9 shows a perspective view of the adapter of FIGS. 2-7 in position relative to the coil assembly of FIG. 1, with pogo connectors contacting the contact pads;

FIG. 10 shows an example of a case for an electronic device with the coil assembly of FIG. 1 affixed to the inner surface of the back of the case and the adapter of FIGS. 2-7 in the charging position relative to the coil assembly and case;

FIG. 11 shows a close-up view of the case of FIG. 10 and in more detail shows the adapter inserted into the aperture of the case in the position that it would be in when inserted into the charging socket of an electronic device (omitted from FIG. 11) contained within the case;

FIG. 12 shows a perspective close-up view of the adapter and lower connecting parts of the coil assembly in more detail than that shown in FIG. 11;

FIG. 13 shows a perspective view of the magnetic connector of the adapter within the aperture as shown in FIG. 11 and particularly when the adapter is in a charging position relative to the case and coil assembly;

FIG. 14 shows a close up view of the lower side of the adapter of FIGS. 2-7 with the holes for pogo connectors drilled in the flange;

FIG. 15 shows a cross-sectional view of one example of a pogo connector suitable for use with the present invention, where both ends of the pogo connector are fully extended;

FIG. 16 shows the pogo connector of FIG. 15 with both ends partly compressed, likely in a similar configuration to that of the connector in use;

FIG. 17 shows the pogo connector of FIG. 15 in a fully compressed configuration;

FIGS. 18-20 show the pogo connector of FIGS. 15-17, respectively, from an external view;

FIG. 21 shows an example of the coil assembly including a circuit board comprising a monitoring circuit.

### DETAILED DESCRIPTION OF THE INVENTION

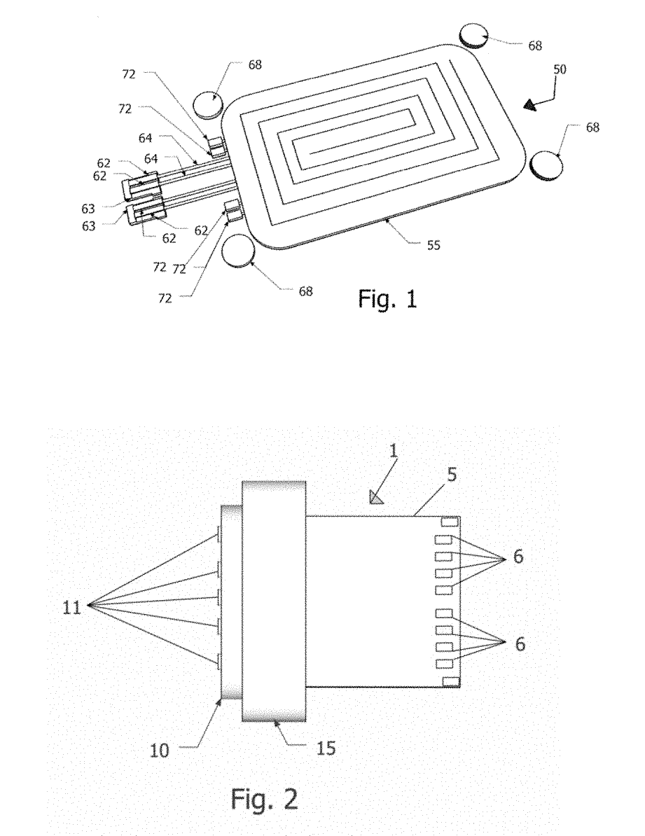

Referring now to the drawings, FIG. 1 shows a coil assembly 50 comprising an inductive receiver coil 55, four ferrous pads in the form of discs 68 (which may or may not be magnetic), a pair of contact blocks 63 with two contact pads 62 affixed to an upper surface of each of the contact blocks 63, and two connecting wires 64 extending between each contact block 63 and the coil 55. Also extending from the coil 55 are two further contact pad connections 72 which are described further below.

The coil 55 in this example is illustrated as being rectangular but this is not limiting and other suitable shapes, e.g. square or circular, may be used. The ferrous discs 68 are positioned at each corner of the coil 55. The ferrous discs 68 are secured to the inner surface of a case 70 for a personal portable electronic device such as a mobile or cell phone, as best seen in FIG. 10. In embodiments where the discs 68 are magnetic, the four discs 68 are arranged so that two discs 68 have their positive poles pointing towards the inner surface of the back of the case 70 and two have their negative poles pointing towards the inner surface of the back of the case 70. This helps to secure the case 70 to a wireless charging device, reducing the likelihood of the case 70 sliding off and possible moving the electronic device out of the range of the wireless charging device, leading to cessation of wireless charging of the electronic device battery.

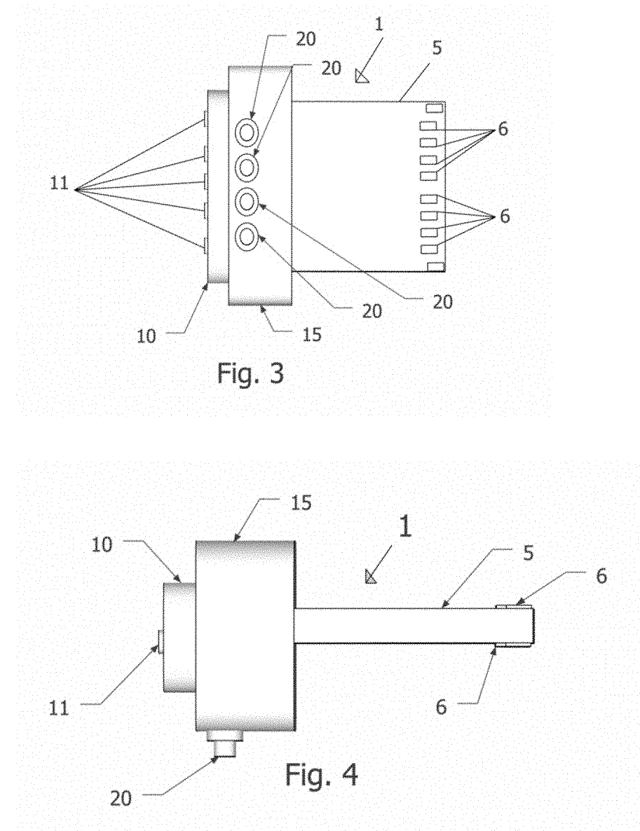

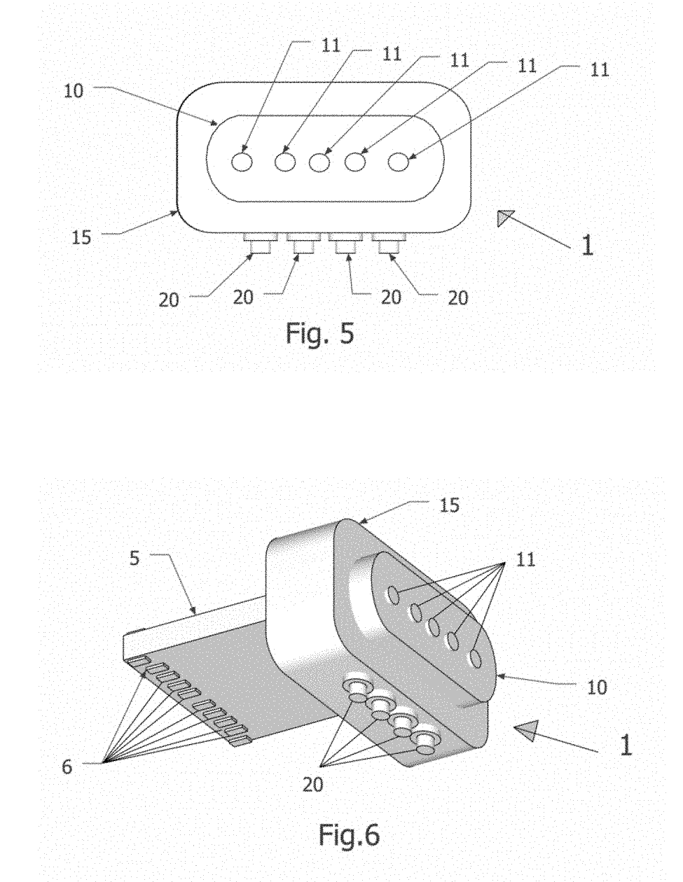

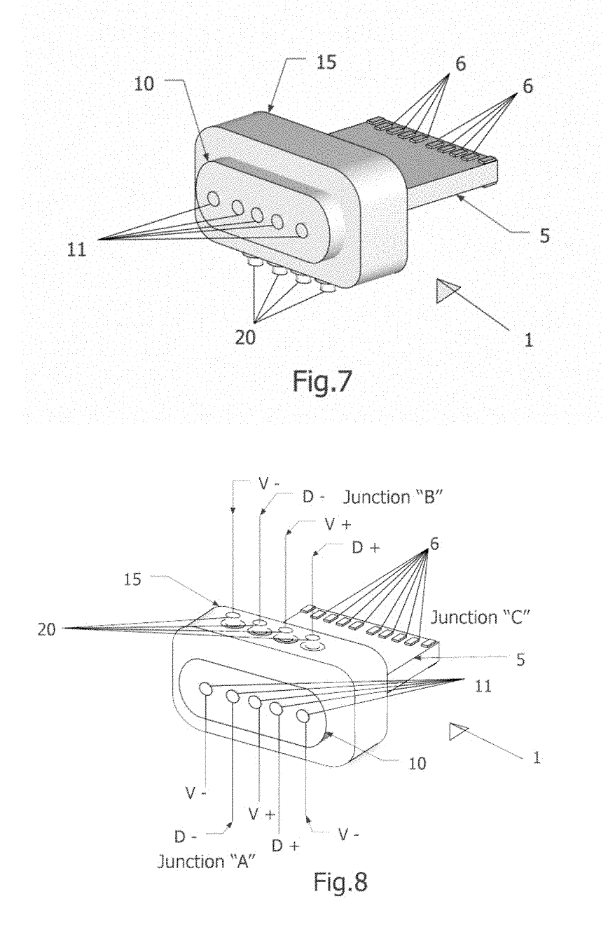

FIGS. 2-8 show the adapter 1 comprising a flange 15, a first end having a tip 5, and a second end having a magnetic connector 10. In these figures, the adapter comprises a Lightning® tip 5 as produced by Apple Inc. of Cupertino, Calif., USA. The tip 5 is purely exemplary and the adapter 1 may be manufactured with any suitable tip having the requisite number/shape/size and type of electrical connectors 6 (e.g. micro USB, USB Type-C, micro USB Type-B, data ports, etc.) to suit the different type of charging and data sockets used by different manufacturers of mobile electronic devices such as mobile telephones and tablets for example. The flange 15 is adapted to abut against the outer surface of an electronic device when the tip 5 is inserted into the charging socket of said electronic device. The flange 15 can have a rectangular or ovalised profile, having longer upper and lower faces than side faces and most preferably has a rectangular profile with rounded corners as shown in FIG. 5.

The (in use) lower face of the flange 15 can be considered to provide a junction such as Junction B (see FIG. 8 where the flange 15 is shown upside down) and which is provided with any suitable number of electrical connectors 20 as will now be described.

At least two holes 23 may be drilled into the lower face of the flange 15 (best seen in FIG. 14), into which electrical connectors, here in the form of pogo connectors 20, are inserted, mounted, or otherwise affixed. More preferably, there are at least four holes 23 drilled into the lower face of the flange 15 as shown in FIG. 14 into which pogo connectors 20 are inserted and mounted. Alternatively, five holes 23 (not shown) may be drilled into the lower face of the flange 15 and further alternatively up to and including five holes 23 (not shown in the figures) may be drilled into the upper face of the flange 15, each hole 23 having a pogo connector 20 mounted therein so that the adapter 1 may be inserted into the charging socket of the mobile electronic device in either orientation and still have the pogo connectors 20 connect with the respective contact pad 62. The pogo connectors 20 are shown in FIG. 5 as protruding from the lower surface of the flange 15. The pogo connectors 20 typically comprise two telescopically arranged portions having a spring arranged there between where the spring is arranged to bias the outermost portion outwardly and the spring is compressed when the outermost portion of the pogo connector 20 is depressed inwardly. The outermost portion is held captive within the innermost portion.

Additionally, if desired or required in further alternative embodiments (not shown), one or more of the other faces of the adapter 1 could be further provided with electrical connectors 20 to allow the adapter 1 to be used in different orientations depending upon requirements. For example, the (in use) upper face of the flange 15 could in further embodiments (not shown) also be considered to provide an additional junction such as Junction D (not shown) and which could be provided with any suitable number of electrical connectors 20 such as for example four electrical connectors 20 and which has the advantage that the adapter 1 could be used in the other (upside down) orientation and operate in a similar manner to when Junction B is in use as will be described subsequently.

Additionally, if desired or required, the (in use) right side face of the flange 15 could in further embodiments (not shown) also be considered to provide an additional junction such as Junction E (not shown) and which could be provided with any suitable number of electrical connectors 20 such as for example two or more electrical connectors 20 and which has the advantage that the adapter 1 could be used in a yet further (right side on) orientation and operate in a similar manner to when Junction B is in use as will be described subsequently.

Additionally, if desired or required, the (in use) left side face of the flange 15 could in further embodiments (not shown) also be considered to provide an additional junction such as Junction F (not shown) and which could be provided with any suitable number of electrical connectors 20 such as for example two or more electrical connectors 20 and which has the advantage that the adapter 1 could be used in a yet further (left side on) orientation and operate in a similar manner to when Junction B is in use as will be described subsequently.

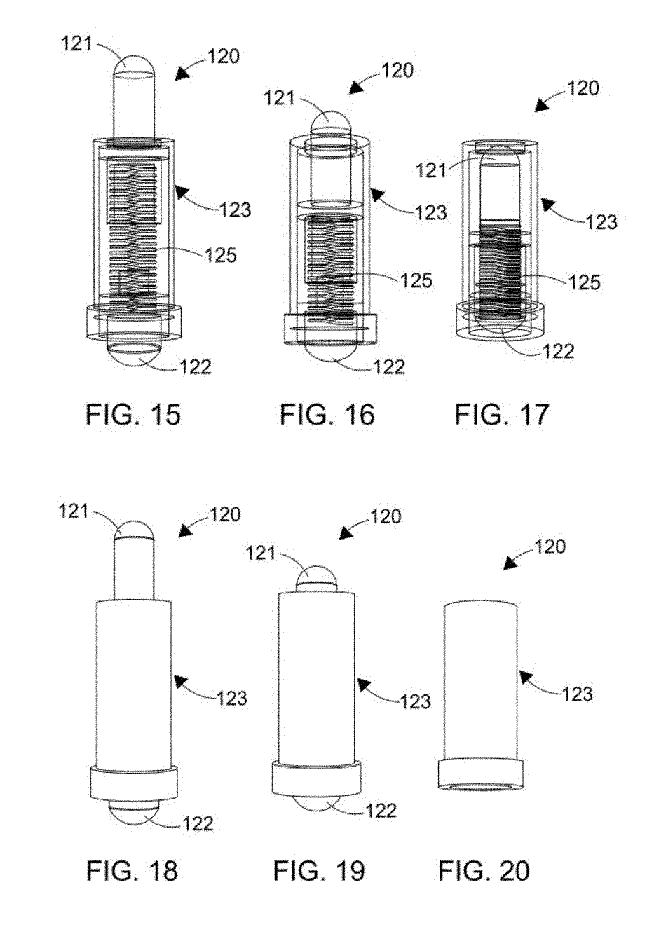

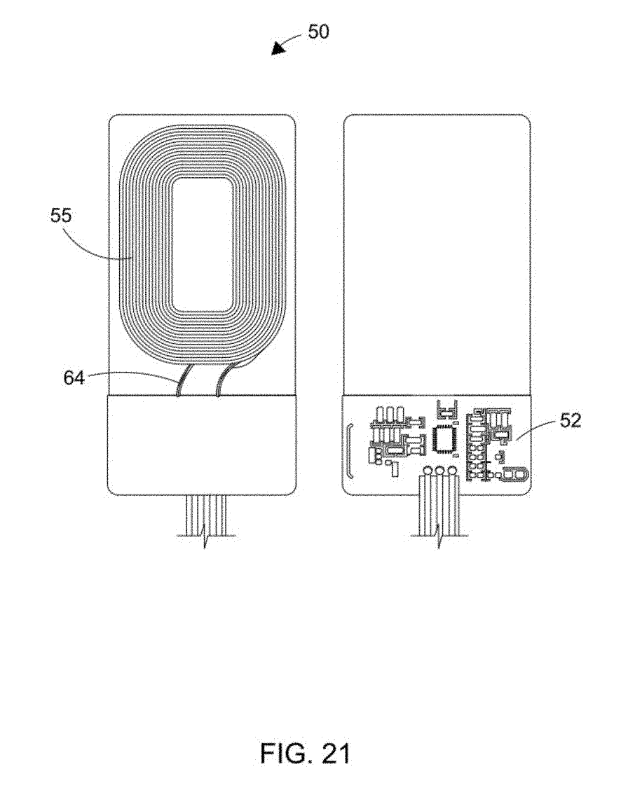

An alternative, and preferred, example of pogo connectors that may be used in the present invention is shown in FIGS. 15-20. This type of pogo connector 120 comprises two movable ends, an inner end 121 that is adapted to be in contact with the circuitry within the adapter 1 and an outer end 122 that is adapted to be in contact with the contact pads 62. The connector 120 further comprises at least one spring mechanism, in this example one coil spring 125, that is optionally coaxial with the longitudinal axis of the pogo connector housing 123 and is optionally configured to bias each end 121, 122 in an outward direction away from the housing 123, such that both the inner 121 and the outer 122 ends are biased in opposite directions. Without any compression being applied, the pogo connector 120 will be fully extended in the configuration shown in FIGS. 15 and 18. When the connector 120 is in position within an adapter and compressed against e.g. contact pads, each end 121, 122 of the connector 120 will be at least partially compressed as shown in FIGS. 16 and 19. The ends 121, 122 of the connector 120 can be compressed to the extent that the ends 121, 122 are disposed within the housing 123 of the connector 120 as shown in FIGS. 17-20.

As both ends of the pogo connector(s) 120 are resiliently biased, the pogo connector 120 is thereby able to absorb relative movement of the adapter 1 and/or the components within the adapter 1 and the contact pads 62. Optionally this enhances the connections between the internal components of the adapter 1 and the contact pads 62. The (or each) pogo connector 120 is arranged such that the inner 121 and outer 122 ends are always under resilient pressure from the spring 125.

The pogo connectors 20 can comprise an insulated sleeve wrapped around at least an electrically conductive portion of the connector 20 that extends within or into the flange 15. The pogo connectors 20, when depressed, therefore extend between and electrically couple the charging circuit within the adapter 1 and the contact pads 62 of the coil assembly 50.

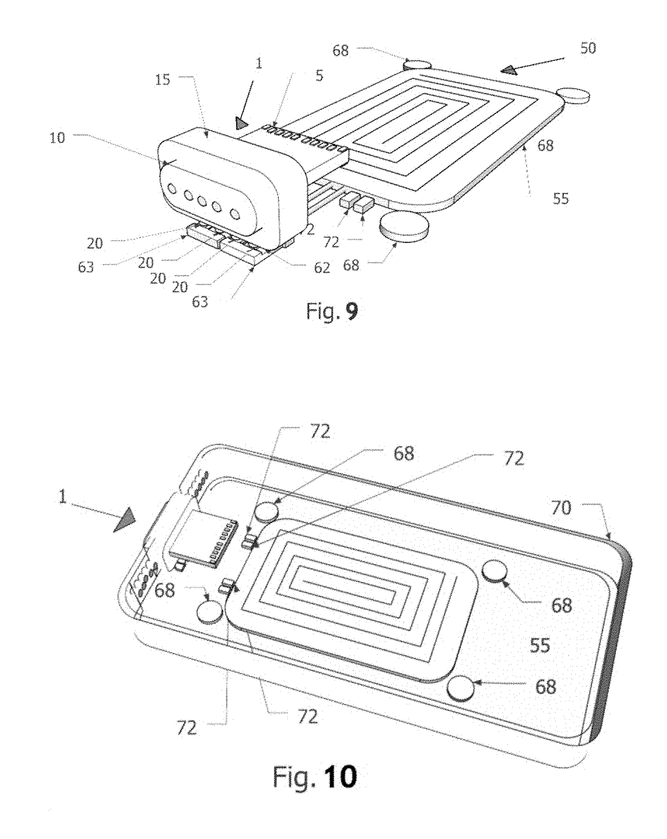

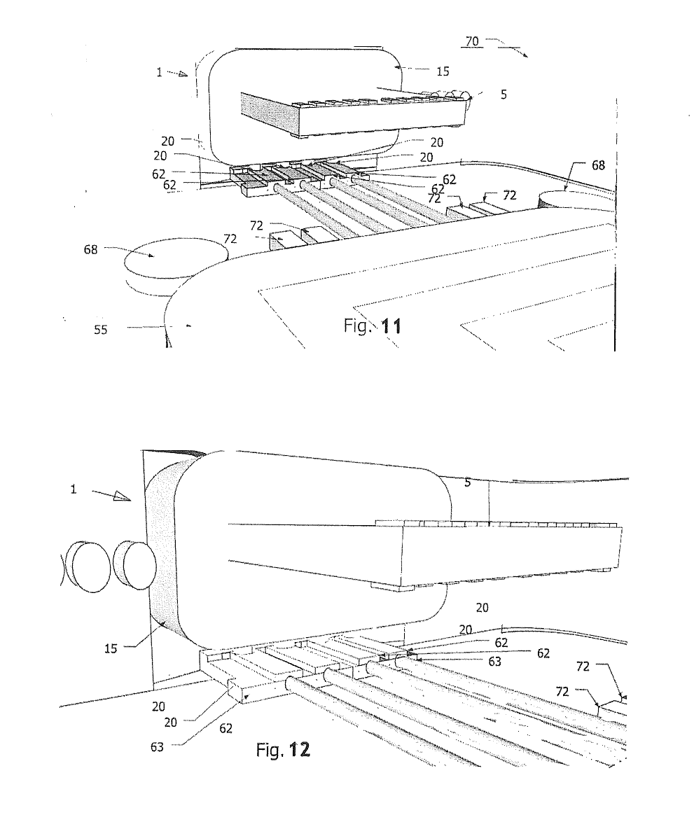

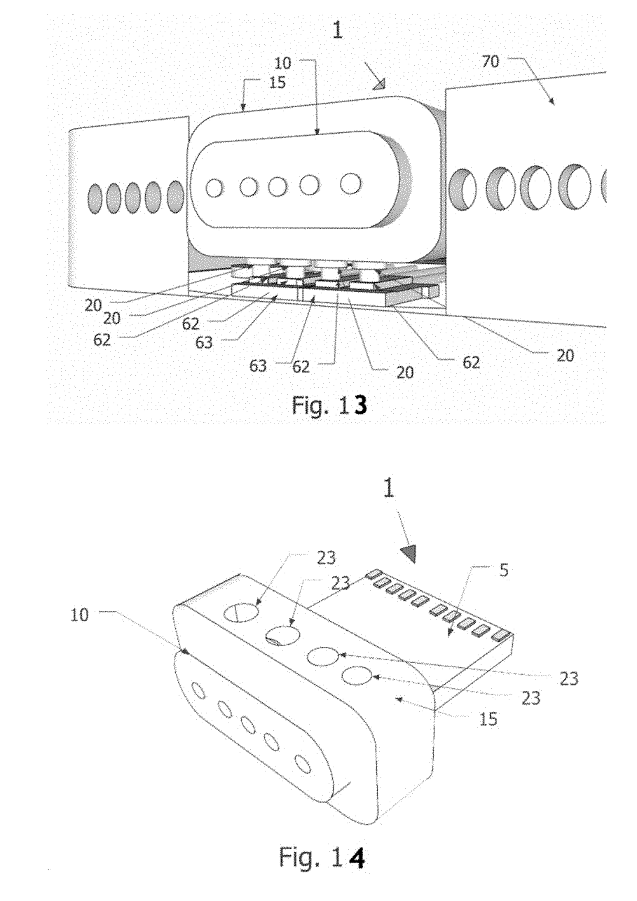

FIG. 9 shows the adapter 1 and the coil assembly 50 in their operative positions relative to one another, and are illustrated with the electronic device and the electronic device case 70 omitted for clarity but which would be present in normal use. The pogo connectors 20 are depressed because they are contacting the contact pads 62 on the contact block 63.

For wireless charging to take place, the inductive receiver coil 55 is energised by a wireless charging device (not shown). The resulting electrical energy within the coil 55 is transferred through the connecting wires 64 to the contact block 63 and thereon to the contact pads 62. As the pogo connectors 20 are in contact with the contact pads 62, the electrical energy travels through the pogo connectors 20 and into the charging circuit of the adapter 1. The tip 5 is, when in use, inserted into the charging socket of an electronic device, and thus electrical energy that is transferred into the adapter 1 is conducted onwards from the electrical contacts 6 provided on the outer end of the tip 5 through the charging socket to the battery device within the electronic device, charging said battery device.

A cable having an end that is complementary to the magnetic connector 10 of the adapter 1 can be connected for wired charging and data transfer. In this case, the electrical energy from the cabled connection travels along electrical sockets/wires 11 V+, V−, D+ and D− (see FIG. 8) provided on an outer face of the magnetic connector 10 and through the magnetic connector 10 and the tip 5 into the charging socket of the electronic device, and onwards to charge the battery device.

Within the adapter 1, there may be further comprised a monitoring circuit (not shown) that can be installed within the flange 15. This circuit may optionally be installed so that a contact point of the circuit may align with one or both holes 23 in the flange 15 such that the monitoring circuit is electrically connected with at least one pogo connector 20, at least when the at least one pogo connector 20 is depressed. In one example, the monitoring circuit connects with the two pogo connector(s) 20 which are in electrical contact with electrical sockets/wires D+ and D− provided in the magnetic connector 10. The monitoring circuit is arranged to detect when wired charging is taking place through a cable such as USB cable (not shown) connected to the magnetic connector 10 and shuts off charging of the electronic device battery via the two pogo connectors 20 which would otherwise be in electrical connection with electrical sockets/wires V+ and V− provided in the magnetic connector 10. Accordingly, wireless and wired charging cannot take place simultaneously and priority is given to wired charging and this has the advantage of preserving the lift of the battery and also provides for safer charging of the battery.

Alternatively and more preferably, the monitoring circuit may be placed within the coil assembly 50 itself as shown in FIG. 21, which illustrates two sides, i.e. front and back, of one example of a coil assembly 50. Optionally the monitoring circuit may be one part of a PCB 52 that may also comprise other functions such as temperature control, or current control. Optionally the monitoring circuit comprises a detection device that detects current flowing back from the adapter 1 when the wired connection is in place. Optionally when the monitoring circuit detects current backflow from the adapter 1, the wireless charging is shut off in order to protect the battery of the electronic device, in preference of allowing direct charging via the charging cable to the data port of the electronic device via the tip 5. An example of a wireless charging receiver coil assembly 50 that comprises a PCB 52 which can be suitably modified to have additional programming to monitor the incoming charging currents, and which will shut off the supply from the coil element of the wireless charging receiver coil assembly 50 is product number QR560-IP having version number RX-15&16, produced by Shenzhen Xingfeichi Technology Company Limited, 4F, Block C, Lian-Ying Tech Park, Sili Rd, Guanlan, Long'Hua District, Shenzhen.

As shown in FIG. 8, the adapter 1 can be considered to have three junctions:—

1) junction A (provided in the magnetic connector 10);
2) junction B (provided by the pogo connectors 20); and
3) junction C (provided by the electrical connectors 6 provided on the tip 5).

Junction A has at least one electrical wire/socket 11 to match each pogo connector 20 of junction B and more preferably, has one more electrical wire/socket 11 in that it has two electrical wire/sockets V− for the one V− pogo connector 20 to provide redundancy, where the V− electrical wire/sockets 11 or V− pogo connector 20 selectively (depending on the detection by the monitoring circuit as described below) carry the −ve DC voltage power supply to the respective −ve voltage electrical connector 6 provided on the tip 5. It then has one electrical wire/socket V+ to match the other DC voltage power supply of the V+ pogo connector 20, where the V+ electrical wire/sockets 11 or V+ pogo connector 20 selectively (again depending on the detection by the monitoring circuit) carry the +ve DC voltage power supply to the respective +ve voltage electrical connector 6 provided on the tip 5.

It also has respective D+ and D− electrical wires/sockets 11 in order to primarily transfer data to and from the mobile electrical device between junctions A and C when the magnetic cable is connected to an external device such as a computer, etc.

Moreover, when the monitoring circuit via junction B detects that junction A is connected to an external source such as a charging station or computer, etc via the magnetic cable, and/or detects current and/or data are flowing through junction A, it switches off any operations being carried out by the charging coil 50 within the case 70 through junctions B and C. Thus, the monitoring circuit permits junctions A and C to both send and receive data via D+ and D− and if necessary charge the battery of the mobile electronic device using sockets V+ and V−. However, if the monitoring circuit detects no operations through junction A (ie the magnetic cable is removed) then the monitoring circuit then allows power and or data to flow between junctions B and C.

Accordingly, the monitoring circuit can control which of junctions A and B are in electrical connection with junction C such that either:

A) the appropriate electrical wires/sockets 11 of junction A are electrically connected with the appropriate electrical connections 6 of junction C; or
B) the appropriate pogo connectors 20, 120 of junction B are electrically connected with the appropriate electrical connections 6 of junction C.

The coil assembly is adapted to be installed within a case 70 for an electronic device as shown in FIG. 10, where the case 70 has a back and sides, the back and sides each having an inner surface generally in contact with the electronic device when one is contained within the case 70 and an outer surface. The inductive receiver coil 55 is secured to the inner surface of the back of the case 70, for example with an adhesive. One side of the case 70 comprises an aperture 75 that is designed to axially align with the charging socket of the electronic device when the electronic device is contained within the case 70. The inductive receiver coil 55 is spaced from the edge of the case 70, to provide room for the different components of the coil assembly 50 if required. The contact block 63 affixes within the aperture 75 in the case 70 to permit contact between the contact pads 62 and the pogo connectors 20 when the adapter 1 is inserted into the charging socket of the electronic device.

Optionally two further connecting wires extend from the coil 55 and electrically connect with two further contact pads that are affixed to the inner surface of the case 70. The case 70 comprises two apertures (not shown) that pass through the back of the case 70 and are aligned with the contact pads 72. These contact pads 72 may be directly connected with a charging device. For example, if the charging device comprises two protruding prongs, these may be inserted into the apertures in the case 70 and abut against the contact pads 72. This can offer a further path for electrical energy to enter the coil 55 and be transferred to the battery device of an electronic device as previously described.

Optionally the case can comprise recesses shaped to receive the components of the coil assembly 50, for example circular recesses to receive the ferrous discs 68. This allows the electronic device to sit flush against the inner surface of the back of the case 70 and reduces the risk of damage to both the electronic device and the coil assembly 50 itself.

Further apertures may be created in the back and sides of the case 70 according to the positioning of buttons, cameras and other aspects of the electronic device that is to be contained and the coil assembly 55 positioned so as to avoid blocking said additional apertures.

Embodiments of the present invention therefore have the great advantage that a suitable adapter 1 having the required tip 5 (such as a Lightning® connector for iOS® devices of Apple Inc.) can be inserted into the charging socket of a user's various different electronic devices and the user can charge or transfer data to/from the electronic device by using one suitable magnetic connector cable which may have eg a USB socket at the other end (thereby avoiding the user having to carry multiple different cables with them) and also has the additional benefit that the user can wirelessly charge their electronic device within a suitable case 70 without having to remove the adapter 1.

Moreover, because the adapter 1 is provided with a separable connection to the coil assembly 50 by means of the pogo connectors 20 provided on the adapter 1 on the one part (ie the mobile electronic device) and the contact pads 62 of the other part (ie the coil 55 and the case 70), the mobile electronic device can be easily removed from the case 70 without having to remove the adaptor 1 from the charging socket of the mobile electronic device and yet the mobile electronic device can still be easily connected to a magnetic charging and/or data transfer cable by means of the magnetic connector 10 on the adapter 1. This further has the advantage that the user doesn't need to insert or remove the tip 5 from the charging socket of the mobile electronic device each time they wish to remove the mobile electronic device from the case 70, thereby significantly extending the operable lifespan of the mobile electronic device because wear and tear of the charging socket of the mobile electronic device is avoided.

Modifications and improvements may be made to the examples and embodiments hereinbefore described without departing from the scope of the invention. For example, other suitable types of connectors could be used instead of the pogo connectors 20, 120 described herein and/or the pogo connectors 20, 120 on the junction B of the adapter 1 could be replaced by contact pads with the contact pads 62 of the contact blocks 63 being replaced by another type of electrical connector such as a solid pins or electric gate system or even contactless transmission or a resiliently biased electrical connector such as a pogo connector or the like.

In addition, and particularly in the future, the adapter 1 may be modified to have many more electrical wires/sockets 11 in junction A and/or many more electrical connectors 20, 120 in junction B and/or many more electrical connectors 6 in junction C as required in order to match different and new types of electrical charging and data sockets provided on portable battery powered electronic devices.

1. A charging apparatus for a battery-powered electronic device, the apparatus comprising:—
a housing for the battery-powered electronic device, the housing further comprising a wireless charging coil assembly adapted to selectively wirelessly charge said battery;
and an adapter having a first end and a second end, the first end comprising a tip adapted to be inserted into a charging socket in the electronic device and the second end comprising a magnetic connector suitable for magnetic connection to a complementary charging or data transfer cable;
wherein the apparatus is characterised by further including at least two electrical connectors disposed on the adapter, and wherein the electrical connectors of the adapter are selectively electrically connected to the tip;
wherein the coil assembly comprises an inductive receiver coil and at least two electrical contacts in electrical connection with the inductive receiver coil;
wherein the electrical connectors on the adapter are arranged to abut the said electrical contacts when the battery powered electronic device is located within the housing when the apparatus is in use; and
wherein the electrical connectors on the adaptor are arranged to be separable from the electrical contacts of the coil assembly when the battery powered electronic device is removed from the housing such that the battery powered electronic device and the adapter inserted in the charging socket can be physically separated from the housing.

2. A charging apparatus as claimed in claim 1, wherein the adapter comprises a flanged portion that abuts against the outer surface of the electronic device when the tip is inserted into the charging socket; wherein two or more holes are provided in the flange, extending between the outer face of the flange to the inner circuitry of the adapter.

3. A charging apparatus as claimed in claim 2, wherein the electrical connectors are fixed into said holes, such that the electrical connectors are at least partially protruding from the outer face of the flange.

4. A charging apparatus as claimed in claim 1, wherein the electrical connectors are resiliently biased in at least an outwards direction such that at least one electrical connector provides a biased connection between itself and the said respective electrical contact of the coil assembly when the respective electrical connector contacts the said respective electrical contact.

5. A charging apparatus as claimed in claim 4, wherein the electrical connectors comprise a respective spring mechanism which when compressed provides a spring-loaded connection between the respective electrical connector and the said respective electrical contact of the coil assembly when the respective electrical connector contacts the said respective electrical contact.

6. A charging apparatus as claimed in claim 1, wherein the electrical contacts of the wireless charging coil assembly are contact pads, wherein the contact pads are aligned with the electrical connectors when the adapter is inserted into a charging socket and when the battery powered electronic device is located within the housing.

7. A charging apparatus as claimed in claim 1, wherein a monitoring circuit is installed within the adapter; wherein at least one of the electrical connectors is in selective electrical connection with the monitoring circuit; wherein the monitoring circuit is adapted to detect both wireless and wired charging occurring simultaneously and, if that simultaneous charging state is detected, is further adapted to switch off the supply of electrical energy from the wireless charging coil.

8. A charging apparatus as claimed in claim 1, wherein a monitoring circuit is installed within the housing, wherein the monitoring circuit is adapted to detect both wireless and wired charging occurring simultaneously and, if that simultaneous charging state is detected, is further adapted to switch off the supply of electrical energy from the wireless charging coil.

9. A charging apparatus as claimed in claim 1, wherein the housing is a case and the coil assembly is adapted to be installed within the case for an electronic device, wherein the case comprises a back and sides, each with an inner surface and an outer surface; wherein the inductive receiver coil is secured to the inner surface of the back of the case, and wherein one side of the case comprises an aperture that axially aligns with the charging socket of the electronic device when the electronic device is contained within the case.

10. A charging apparatus as claimed in claim 9, wherein at least two wires extend from the coil towards the aperture in the case, wherein at least two contact pads are affixed to a contact block within which the wires terminate, and wherein the contact pads electrically connect to the wires within a contact block upon which the contact pads are affixed; wherein the contact pads are adjacent to the charging socket of the electronic device when the electronic device is contained within the case; wherein the contact block affixes within the aperture in the case to permit contact between the contact pads and the electrical connectors when the adapter is inserted into the charging socket of the electronic device and when the case is provided or fitted around the battery-powered electronic device.

11. A charging apparatus as claimed in claim 10, wherein the connection between the electrical connectors and the contact pads adjacent to the charging socket is adapted to selectively allow transfer of electrical energy between the electrical connectors and the contact pads when the inductive receiver coil is exposed to an electromagnetic field.

12. A charging apparatus as claimed in claim 1, wherein at least two wires extend from the coil and electrically connect with at least two contact pads that are affixed to an inner surface of a case adapted to contain the electronic device; wherein the case comprises apertures that are aligned with the contact pads, and wherein said contact pads may be directly connected with a charging device where that charging device comprises at least one protruding electrical connector; wherein the at least one protruding electrical connector is adapted to be inserted into at least one of the apertures in the case and abut against the contact pads affixed to the inner surface of the case.

13. A charging apparatus as claimed in claim 1, wherein the charging apparatus further comprises two or more ferrous pads secured to an inner surface of a case adapted to contain the electronic device, wherein at least one ferrous pad is magnetic and arranged so that its positive pole is directed away from the electronic device when the electronic device is received within the housing; and wherein at least one other magnetic ferrous pad is arranged so that its negative pole is directed away from the electronic device when the electronic device is received within the housing.

14. A charging apparatus as claimed in claim 9, wherein the housing comprises recesses shaped to receive the components of the coil assembly to permit the electronic device to sit flush against the inner surface of the back of the housing when the electronic device is contained within said housing.

15. A charging apparatus as claimed in claim 1, wherein the magnetic connector on the adapter is adapted to connect to a magnetic cable for wired charging and/or data transfer.

16. A wireless charging coil assembly for a battery-powered electronic device, wherein the coil assembly comprises an inductive receiver and is characterised by comprising at least two electrical contacts configured to selectively connect to at least two corresponding electrical connectors disposed on an adapter configured to be received within a charging socket of the electronic device;
characterised in that the electrical contacts of the coil assembly are arranged to be separable from the electrical connectors of the adaptor when the battery powered electronic device is removed from the coil assembly such that the battery powered electronic device and the adapter inserted in the charging socket can be physically separated from the coil assembly.

17. An adapter having a first end and a second end, the first end comprising a tip adapted to be inserted into a charging socket in an electronic device, and the second end comprising a magnetic connector suitable for magnetic connection to a complementary charging or data transfer cable;
wherein the adapter is characterised by further comprising at least two electrical connectors disposed on the adapter, and wherein the electrical connectors are configured to connect to at least two electrical contacts in electrical connection with a wireless charging coil assembly;
characterised in that the electrical connectors on the adaptor are arranged to be separable from the electrical contacts of the coil assembly when the battery powered electronic device is removed from the wireless charging coil assembly such that the battery powered electronic device and the adapter inserted in the charging socket can be physically separated from the wireless charging coil assembly.
